(19) United States
(12) Patent Application Publication
(10) Pub. No.: US 2024/0307799 A1
(43) Pub. Date: Sep. 19, 2024

(54) FILTER DISK, DEVICE FOR DEWATERING SLUDGE, AND USE OF A FILTER DISK

(71) Applicant: HUBER SE, Berching (DE)

(72) Inventor: Walter Blomenhofer, Berching/Pollanten (DE)

(21) Appl. No.: 18/585,463

(22) Filed: Feb. 23, 2024

(30) Foreign Application Priority Data
Mar. 14, 2023 (DE) 10 2023 106 346.4

(51) Int. Cl. B01D 33/15; C02F 11/121

(52) U.S. Cl. CPC B01D 33/15; C02F 11/121

(57) ABSTRACT

In one aspect, a filter disk for a device for dewatering sludge includes a screening plate. The screening plate has a plurality of openings for the passage of liquid and is substantially circular. Additionally, the filter disk has a supporting structure for supporting and/or stiffening the screening plate, wherein the supporting structure has at least one annular section.

### CROSS-RELATED TO RELATED APPLICATIONS

The present application is based upon and claims the right of priority to German Patent Application No. 10 2023 106 346.4, filed Mar. 14, 2023, the disclosure of which is hereby incorporated by reference herein in its entirety for all purposes.

### FIELD OF THE INVENTION

The present subject matter relates generally to a filter disk for a device for dewatering sludge, and more particularly to a filter disk including a screening plate that has a plurality of openings for the passage of liquid and that is substantially circular. The present subject matter also relates to a device for dewatering sludge and to a use of a filter disk.

### BACKGROUND OF THE INVENTION

EP 1 194 383 A1 discloses a device for dewatering sludge, in particular thin sludges, by means of a screening surface for receiving the sludge, with the thin sludges arising, for example, during operation of sewage treatment plants. The screening surface has openings for the passage of liquid, with the screening surface being substantially circular and being rotatable about an axis extending perpendicularly to the screening surface. According to the prior art, the screening surface preferably consists of a support surface which is covered with a coarse material separator. The disadvantage with this configuration is that the coarse material separator is usually in the form of a cloth covering, which, in turn, results in production complications and can also lead to increased production costs. In addition, the cloth coverings usually have a very fine mesh, as a result of which the throughput through the screening surface is reduced. Accordingly, there is a need for a filter disk and a related device that eliminates the disadvantages known from the prior art.

### SUMMARY OF THE INVENTION

In various aspects, the present subject matter is directed to a filter disk, a device for dewatering sludge, and a use of a filter disk having the features described and claimed herein.

In one aspect, the present subject matter relates to a filter disk for a device for dewatering sludge, the filter disk including a screening plate that has a plurality of openings for the passage of liquid and that is substantially circular.

The device for dewatering sludge is preferably in the form of a disk thickener. Disk thickeners are frequently used for treating waste water, in particular in sewage treatment plants. Disk thickeners have the advantage of being space-saving and simply designed. In particular, such a disk thickener is well suited for thin sludges and/or conditioned sludges, since a compact and/or cost-effective design is possible.

For dewatering the sludge, the device includes a filter disk which is preferably arranged in a tank of the device. The sludge is preferably arranged or applied above the screening plate, as a result of which natural gravity can be used for dewatering the sludge. Additionally or alternatively, at least one roller and/or one baffle can compress and/or distribute the sludge to ensure an unimpeded and consistent outflow of liquid. The liquid, in particular the water, can drain through the openings in the screening plate and/or be collected below the screening plate. The filter disk preferably rotates about a rotational axis inside the tank during the intended use of the device.

According to one aspect of the present subject matter, the filter disk has a supporting structure for supporting and/or stiffening the screening plate, the supporting structure having at least one annular section. A screening plate should be understood to be a substantially circular plate which has a certain rigidity against deflection. The outer contour of the substantially circular plate is therefore circular or round. The screening plate has a substantially constant plate thickness within this circular or round contour. Since the screening plate has openings, this can also be referred to as a perforated plate. These openings penetrate the substantially constant wall thickness substantially normally to the plate surface. The screening plate is usually retained and supported in the device in the center, i.e., in the region of the rotational axis, and/or on the outside, i.e., at its periphery. Additionally or alternatively, the screening plate can be retained and supported in the device at the annular sections and/or at the supporting structure.

The screening plate can become unstable, however, depending on the plate thickness, hole pitch and/or mesh width. Although the term “mesh width” is usually used for a square or rectangular mesh fabric, it can also be used in the same sense for round openings. The term “hole pitch” and “perforation” is more appropriate in this context, however. Hole pitch refers to the distance from the center of hole to the center of hole in two adjacent holes or rows of holes in the screening plate. Perforation should be understood as the size and the diameter of the openings. In general, the larger the openings and/or the shorter the distance, the more unstable the screening plate becomes. The aforementioned variables are usually dependent on one another, however. For example, when there are smaller openings, the distance to one another is usually also shorter, as a result of which perforated plates having smaller openings usually have a lower stability than perforated plates having larger openings. Perforated plates with smaller openings have the advantage, however, that an additional cloth covering with a mesh fabric is not necessary. Such mesh fabrics have the disadvantage that an additional production step and an additional supporting structure, for example, a perforated plate having large openings, is necessary, which increases the production costs. In addition, such mesh fabrics have a very low mesh width, which reduces the throughput, i.e., the amount of liquid passing through per unit of time. The service life of the mesh fabric can also be reduced.

The screening plate can be supported, carried, and/or stiffened by means of the supporting structure. Screening plates having a highly limited stability but also a high throughput can also be used. The necessary stability is ensured primarily by the supporting structure with the at least one annular section. As a result, an undulation or a local deflection of the screening plate can be avoided.

An annular section should be understood as a section of the supporting structure, at least a portion of which extends transversely to a radial direction of the screening plate. The radial direction extends radially from the center of the screening plate to the outer side of the screening plate. As a result, the stability can be increased transversely to the radial direction. In addition, as a result, a support surface for the screening plate, at least a portion of which extends transversely to the radial direction, can be created, thereby allowing the screening plate to be uniformly supported.

It is advantageous when the at least one annular section or a plurality of adjacently arranged annular sections form(s) at least one stiffening ring. The stiffening ring therefore substantially extends around the rotational axis, thereby allowing the stability to be further increased.

Additionally or alternatively, the stiffening ring has the shape of a circle or, or a polygon, particularly a regular polygon. Since the screening plate is also substantially circular, the screening plate can be supported as uniformly as possible and/or in a manner matching the shape by means of the at least one circular stiffening ring and/or multiple circular stiffening rings. The stiffening ring, which is, in one embodiment, in the form of a regular polygon, can also ensure a similar or identical support, depending on the number of corners. In addition, it is possible that stiffening rings in the shape of a regular polygon have reduced manufacturing costs.

Additionally or alternatively, the stiffening ring is endless. A stiffening ring that is joined at available ends (for example, after a bending process step) to form an endless stiffening ring should also be considered endless. The endless or closed stiffening ring has very high stiffness, thereby allowing the ring to accommodate a heightened torsion about the rotational axis.

Moreover, it is advantageous when the at least one annular section and/or the at least one stiffening ring extend(s) concentrically about a rotational axis of the filter disk. Since the filter disk with the screening plate rotates about the rotational axis during the intended use of the device, the concentric design of the at least one stiffening ring allows for a uniform support effect. In addition, the design allows for any imbalances to be eliminated or reduced.

It is also advantageous when the supporting structure includes at least one radial section, the radial section extending preferably substantially straight along a radial direction of the filter disk. The at least one radial section stiffens the screening plate in addition to the annular section.

It is advantageous when the at least one annular section and the at least one radial section are connected to one another at a connecting section. Since the at least one annular section extends transversely to the radial direction, the at least one annular section and the at least one radial section advantageously meet at the connecting section. Preferably, the at least one annular section and the at least one radial section are connected to one another at the connecting section such that an interconnected supporting structure is formed. This creates stability that is as high as possible along the radial direction and transversely to the radial direction.

It is also advantageous when the at least one annular section and/or the at least one radial section have/has a constant cross-section, which allows for reduced manufacturing costs. For example, it is conceivable that the at least one annular section and the at least one radial section are made of the same, preferably strand-like, starting material. It is also conceivable to cut the strand-like material to the appropriate length and to leave the strand-like material straight or form the material to be straight for the radial section. For the annular section, the strand-like material can be bent in the shape of a circle and/or joined straight in sections such that the stiffening ring can be formed.

For example, with respect to the filter disk, which preferably has a diameter from 1000 mm to 2000 mm, preferably 1400 mm to 1700 mm, the at least one annular section and/or the at least one radial section can have a cross-section with a constant section height in the range from 20 mm to 40 mm, preferably 25 mm to 35 mm, and a constant section width in the range from 5 mm to 15 mm, preferably 7 mm to 12 mm. The screening plate has a plate thickness, for example, in the range from 0.5 mm to 1.2 mm, preferably 0.7 mm to 1 mm.

Moreover, it is advantageous when the at least one annular section and the at least one radial section each include at least one correspondingly designed connecting recess such that the at least one annular section and the at least one radial section are insertable into one another in the region of the corresponding connecting recesses and form the connecting section. The respective connecting recesses are preferably designed such that these each have half the cross-section of the at least one annular section and the at least one radial section. As a result, both the at least one annular section and the at least one radial section can be designed without interruptions or to be endless, which allows these sections to be weakened as little as possible by the connecting section. Production can be facilitated and accelerated by using this design as well, since the sections merely need to be inserted into one another. Additionally or alternatively, the at least one annular section and the at least one radial section can be connected to one another in the region of the connecting recesses, for example, by means of a welded joint.

It is also advantageous when the at least one annular section and the at least one radial section are connected to one another, in particular, in a non-displaceable manner. The supporting structure formed in this way, including the non-displaceably connected annular section(s) and radial section(s), ensures very high stability at the lowest possible weight.

It is also advantageous when the supporting structure includes multiple stiffening rings, which are spaced apart from one another, in particular uniformly, along the radial direction. A uniform support effect or stiffening effect of the supporting structure can be achieved in this way.

It is also advantageous when the supporting structure has multiple radial sections, the radial sections being offset, preferably uniformly, from one another by an angle. This also contributes to the uniform support effect and stiffening effect of the supporting structure. For example, such a supporting structure can be cobweb-like.

It is advantageous when the screening plate is of a multi-part design, in particular, a two-part, design. The two screening plate halves or the multiple screening plate sections contribute to a simpler manufacture of the filter disk, since the size of the screening plate is divided.

It is advantageous when the screening plate has a hole pitch in the range from 0.5 mm to 4 mm, preferably from 1 mm to 3 mm. Moreover, it is advantageous when the screening plate includes round and/or polygonal openings, the openings having a hydraulic diameter in the range from 0.5 mm to 2 mm, preferably from 0.8 mm to 1.2 mm. Therefore, the screening plate preferably has a perforation with a diameter in the range from 0.5 mm to 2 mm, preferably from 0.8 mm to 1.2 mm. As described above, the spacing of the openings depends mostly on the diameter of the opening. The polygonal openings can be, for example, rectangular, square, triangular and/or polygonal, in particular pentagonal, hexagonal or honeycomb-shaped openings. For example, at a diameter of 1.1 mm, the distance between the centers of the openings and, thus, the hole pitch can be approximately from 1 mm to 3 mm, preferably 2 mm. The aforementioned hole pitch or the aforementioned diameter of the opening is very fine for the screening plate in contrast to the prior art. As a result, additional mesh fabric is not needed, thereby eliminating any method step associated therewith. Therefore, the production costs can be reduced. In addition, the throughput of the screening plate can be optimally designed. In the prior art, this throughput is considerably less due to the two-ply design with the mesh fabric having a mesh width of approximately 0.3 mm and the screening plate having openings with a diameter of approximately 3 mm.

It is also advantageous when the filter disk has an outer fastening contour and/or an inner fastening contour. The screening plate can be fastened by means of the outer fastening contour and/or the inner fastening contour. Additionally or alternatively, the screening plate can also be mounted and/or fastened inside the device by means of the outer fastening contour and/or the inner fastening contour. The inner fastening contour fastens the filter disk preferably on a drive shaft of the device. The outer fastening contour is preferably designed such that the filter disk can be placed on and/or slide on the tank of the device. The tank can have, for example, a collar, against which the outer fastening contour can be indirectly or directly supported.

It is additionally advantageous when the supporting structure, the outer fastening contour and/or the inner fastening contour have/has a support surface for the screening plate. By means of the support surface, the supporting structure, the outer fastening contour and/or the inner fastening contour rest(s) directly or indirectly on the screening plate, for example, by means of a spacer. This creates a placement that is as uniform and flat as possible. In addition, the screening plate can be connected to the supporting structure, the outer fastening contour and/or the inner fastening contour by means of the support surface, in particular in a non-displaceable manner.

It is advantageous when the supporting structure, the screening plate, the outer fastening contour and/or the inner fastening contour are, in particular directly, adjacently arranged and/or non-displaceably connected to one another. The filter disk, which consists of the supporting structure, the screening plate, the outer fastening contour and/or the inner fastening contour, forms a unit. This unit forms a very high rigidity at the lowest possible weight.

It is also advantageous when the filter disk includes at least one sliding element for placing the filter disk on a tank of the device and/or sliding the filter disk on a tank of the device. As described above, the filter disk can slide on a collar of the tank. For this purpose, the sliding element can be made of a material which is suitable for the purpose of sliding. For example, the sliding element is made of a polymer. It is thus possible to avoid the filter disk becoming damaged when sliding along the tank. In addition, the sliding element can be easily replaced when damage does occur or after a specified service life.

It is additionally advantageous when the sliding element is arranged on the outer fastening contour, preferably on a side of the outer fastening contour situated opposite the screening plate. According to the above-described section heights of the at least one annular section and/or of the at least one radial section, the sliding element together with the outer fastening contour preferably has a constant section height in the range from 20 mm to 40 mm, in particular 25 mm to 35 mm. The outer fastening section and the sliding element preferably each have a section height from 10 mm to 20 mm, in particular 12.5 mm to 17.5 mm.

The present subject matter further relates to a device for dewatering sludge, in particular a disk thickener. The device includes a filter disk for receiving the sludge and a tank in which the filter disk is mounted to as to be rotatable about a rotational axis.

According to one aspect of the present subject matter, the filter disk is designed according to the preceding description, wherein the aforementioned features can be present individually or in any combination. The advantages that result from the filter disk according to the present subject matter are clear from the preceding description. Due to the use of the disclosed filter disk in the device, it is additionally conceivable that a drive uses less power due to the reduced weight and/or mass inertia in combination with the same rigidity. Moreover, the productivity of the device can be increased due to the higher throughput of the filter disk.

The present subject matter also relates to a use of a filter disk in a device for dewatering sludge. The filter disk is designed according to the preceding description, wherein the aforementioned features can be present individually or in any combination.

It is advantageous when the device for dewatering sludge is designed according to the preceding description, wherein the aforementioned features can be present individually or in any combination.

### BRIEF DESCRIPTION OF THE FIGURES

Further advantages of the invention are described in the following exemplary embodiments, wherein:

FIG. 1 shows a schematic, partial cutaway side view of a device for dewatering sludge,

FIG. 2 shows a perspective view of a filter disk,

FIG. 3 shows a cutaway side view of a sub-region of the filter disk from FIG. 2, and

FIG. 4 shows a detailed view of a supporting structure of the filter disk from FIGS. 2 and 3 in a perspective view.

### DETAILED DESCRIPTION

In the following description of the figures, the same reference characters are used for features that are identical and/or at least comparable in each of the various figures. The individual features, their embodiment and/or mode of operation are explained in detail usually only upon the first mention thereof. If individual features are not explained in detail once more, their embodiment and/or mode of operation correspond(s) to the embodiment and mode of operation of the features that act in the same way or have the same name and have already been described.

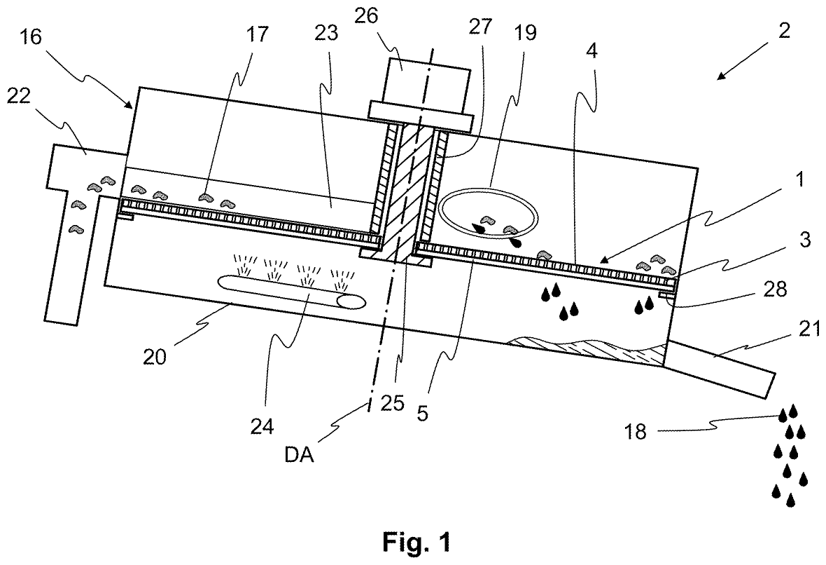

FIG. 1 shows a schematic, partial cutaway side view of a device 2 for dewatering sludge 17. The device 2 is in the form of a disk thickener in the exemplary embodiment shown in FIG. 1. The device 2 has a filter disk 1 for receiving the sludge 17 and a tank 16, with the filter disk 1 being mounted inside the tank 16 so as to be rotatable about a rotational axis DA. The tank 16 can be supported, for example, by means of supports, which are not shown, however, for the sake of clarity. At least one of the supports can be adjustable in length such that the device 2 can be inclined.

The tank 16 has a least one inlet 19 for the sludge 17. The sludge 17 has high moisture and a high water content when introduced through the inlet 19. In order to simplify the view, the sludge 17 and the liquid 18 or water have been shown separately as individual particles in the exemplary embodiment. In reality, the sludge 17 and the liquid 18 form “wet sludge” or thin sludge.

The mode of operation of the device 2 shown in FIG. 1, which is in the form of a disk thickener, is briefly explained in the following. The sludge 17 is preferably conditioned with flocculant. As is known from the prior art, thin sludge is treated with these flocculants in order to ensure a better separation of liquid 18 from the sludge 17. The sludge 17, in particular the conditioned thin sludge, is applied onto the top side of the filter disk 1 via the inlet 19. The filter disk 1 is rotated about the rotational axis DA such that the sludge 17 is conveyed away from the region of the inlet 19, provided the sludge 17 does not flow away on its own. Dewatering takes place as soon as the sludge 17 is applied on the filter disk 1. For this purpose, the filter disk 1 includes a screening plate 3 having openings 4, through which the liquid 18, or the water in the sludge 17, flows due to gravity.

The liquid 18 is collected in the region of a base 20 of the tank 16 and/or is conveyed to an outlet 21. As described above, the device 2 and, thus, the tank 16 can be inclined. Due to the inclination or slant, the separated liquid 18 can be easily and/or continuously discharged through the low outlet 21. The sludge 17 initially accumulates above the filter disk 1 in the region of the outlet 21 due to the inclination. However, due to the rotary motion of the filter disk 1, the sludge 17 is carried along and forms a layer on the screening plate 3. This allows the sludge 17 to be conveyed by the screening plate 3 to an outlet 22, with the dewatered sludge 17 being discharged from the device 2 at the outlet 22. Liquid 18 is continuously removed from the sludge 17 along the entire transport route of the sludge 17. The liquid 18 is collected underneath the filter disk 1 at the base 20 of the tank 16 and is discharged through the outlet 21.

During the transport of the sludge 17 from the inlet 19 to the outlet 22, at least one roller and/or baffle (not shown) can act on the sludge 17 by compressing and/or distributing the sludge 17 in order to improve the dewatering. In the region of the outlet 22, the device 2 has a scraper 23, with which the dewatered sludge 17 is scraped from the screening plate 3 and/or guided in the direction of the outlet 22. For this purpose, the scraper 23 can have, for example, a curved shape. In addition, in the exemplary embodiment shown, an optional cleaning unit 24 is arranged between the scraper 23 and the inlet 19. By means of the cleaning unit 24, the screening plate 3 can be cleaned after the sludge 17 has been removed, such that the screening plate 3 is not constrained by contamination. The cleaning unit 24 extends radially from the rotational axis DA to an outer wall of the tank 16, such that the entire working width of the filter disk 1 is cleaned prior to the application of new sludge 17.

The device 2 includes a drive shaft 25 in order to mount the filter disk 1 inside the tank 16 so as to be rotatable about the rotational axis DA. The filter disk 1 can be driven via the drive shaft 25 by means of a drive 26. The drive shaft 25 is enclosed by a sleeve 27, which does not rotate, and fixedly mounts the scraper 23. The filter disk 1, which is arranged in the interior of the tank 16, extends perpendicularly to the rotational axis DA and is circular. The inner diameter of the tank 16 is substantially identical to the outer diameter of the filter disk 1 and of the screening plate 3. The filter disk 1 is fixedly connected to the drive shaft 25 in the center of the filter disk 1. On the outer side, i.e., on the periphery, the screening plate 3 is preferably supported by a collar 28.

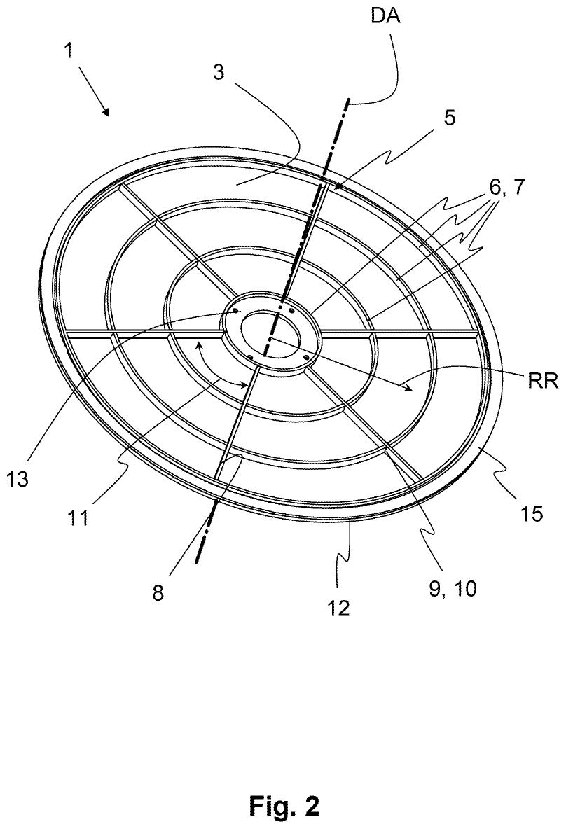

The preceding description of the device 2 should be understood as an example of the device 2, which is in the form of a disk thickener. It is also conceivable that a filter disk 1 according to the present subject matter is arranged in alternative devices. The filter disk 1 in the exemplary embodiment shown in FIG. 1 includes a schematically shown supporting structure 5 for supporting and/or stiffening the screening plate 3. This supporting structure 5 is explained in greater detail in the following description of FIGS. 2 through 4.

FIG. 2 shows a perspective view of a filter disk 1. The illustrated filter disk 1 can be used, for example, in a device 2 for dewatering sludge 17 according to the exemplary embodiment from FIG. 1. FIG. 2 shows the filter disk 1 in a perspective view from underneath. As such, the supporting structure 5 for supporting and/or stiffening the screening plate 3 can be viewed in FIG. 2.

In the exemplary embodiment shown in FIG. 2, the supporting structure 5 includes multiple annular sections 6 by way of example. It is also conceivable that the supporting structure 5 has only one of the annular sections 6. Each of the annular sections 6 in the exemplary embodiment shown forms a stiffening ring, preferably a circumferential stiffening ring. It is also conceivable that the stiffening ring 7 is formed from a plurality of adjacently arranged annular sections 6. In addition, the stiffening ring 7 in the exemplary embodiment shown is circular or in the form of a circle. Alternatively, it is also conceivable that the stiffening ring 7 has the shape of a regular polygon.

In the exemplary embodiment shown, the annular sections 6 form the supporting structure 5 together with one or more radial sections 8. The supporting structure 5 with the at least one radial section 8 additionally stiffens the screening plate 3 along a radial direction RR of the filter disk 1. Due to the plurality of radial sections 8 and the plurality of annular sections 6, the supporting structure 5 is cobweb-like. In the illustrated embodiment, in order to ensure the most uniform support of the screening plate 3 possible, the multiple stiffening rings 7, which extend, in particular, concentrically to the rotational axis DA, are uniformly spaced apart from one another along the radial direction RR. Additionally, in the exemplary embodiment shown, the radial sections 8 are uniformly offset from one another by an angle 11. At the regions at which the at least one annular section 6 meets the at least one radial section 8, these are connected to one another, preferably in a non-displaceable manner. These regions can be referred to as connecting sections 9.

As described above, the filter disk 1 shown in FIG. 2 can be used in a device 2 according to FIG. 1. In order to fasten the filter disk 1 to the drive shaft 25 in accordance with the embodiment shown in FIG. 1, the filter disk 1 shown in FIG. 2 has an inner fastening contour 13. Additionally or alternatively, the screening plate 3 can be non-displaceably connected to the supporting structure 5 by means of the inner fastening contour 13 and/or an outer fastening contour 12. For this purpose, for example, the inner fastening contour 13 and/or the outer fastening contour 12 are/is connected to the supporting structure 5, in particular in a non-displaceable manner. Additionally or alternatively, a sliding element 15 can be arranged on the outer fastening contour 12, the sliding element 15 being designed to slide on the collar 28 of the tank 16 (see FIG. 1).

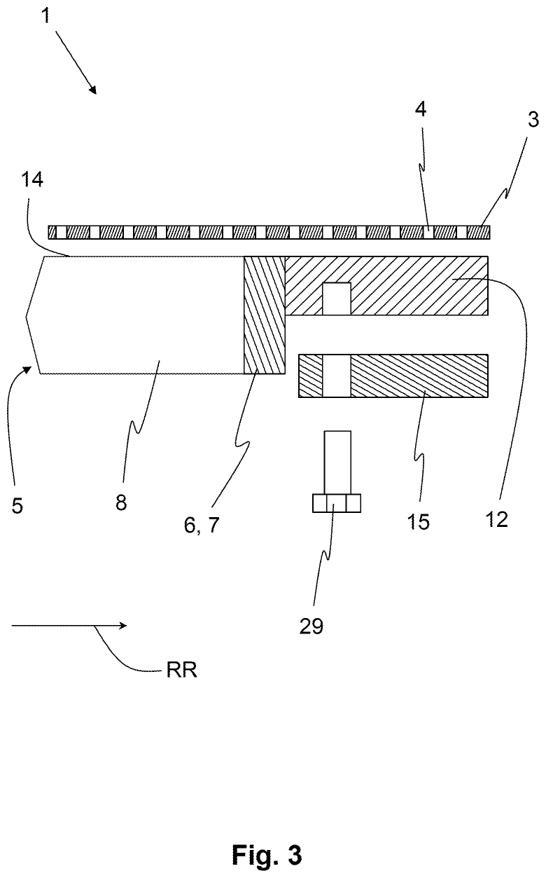

FIG. 3 shows a cutaway side view of a sub-region of the filter disk 1 from FIG. 2. The sub-region includes the outer fastening contour 12 and the outermost stiffening ring 7 and the associated portion of the screening plate 3. In addition, a portion of one of the radial sections 8 is shown in FIG. 3.

The supporting structure 5, which includes the at least one annular section 6 and the at least one radial section 8 in the exemplary embodiment shown in FIG. 3, form, together with the outer fastening contour 12, a support surface 14 on the top side of the structure 5 for the screening plate 3. It is also advantageous when the inner fastening contour 13 also includes a portion of the support surface 14 for the screening plate 3. The screening plate 3 can rest on the supporting structure 5, the outer fastening contour 12 and the inner fastening contour 13 and/or can be connected thereto, in particular in a non-displaceable manner.

Moreover, the sliding element 15 arranged on the outer fastening contour 12 is shown in greater detail in the present sectional view of FIG. 3. The sliding element 15 is connected to the outer fastening contour 12 by means of a fastening element 29. The sliding element 15 is arranged on the underside of the outer fastening contour 12. The support surface 14 for the screening plate 3 is arranged on the top side of the outer fastening contour 12, as described above. Since the screening plate 3 is retained and supported according to aspects of the present subject matter by the supporting structure 5, the screening plate 3 can be less rigid than is generally known from the prior art. The supporting structure 5 provides most of the necessary rigidity of the filter disk 1. In the exemplary embodiment shown, the screening plate 3 has round openings 4, the openings 4 having a diameter in the range from 0.5 mm to 2 mm, preferably from 0.8 mm to 1.2 mm. Polygonal openings 4 are also conceivable. The hydraulic diameter of these openings 4 can be designed similarly to those of round openings 4. The hole pitch can be selected, for example, in the range from 0.5 mm to 4 mm, preferably from 1 mm to 3 mm. Such hole pitches or diameters of the opening 4 usually result in a very low rigidity of the screening plate 3. The necessary rigidity for the filter disk 1 can be provided primarily by the supporting structure 5.

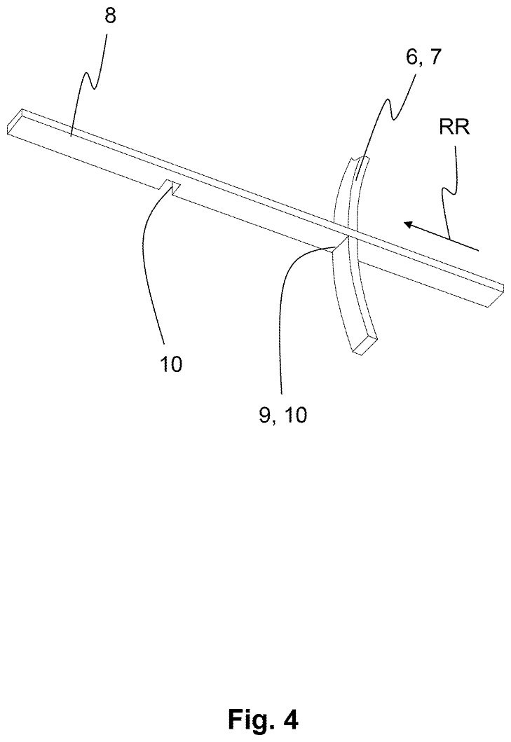

FIG. 4 shows a detailed, perspective view of a portion of a supporting structure 5 of the filter disk 1 from FIGS. 2 and 3. The exemplary embodiment from FIG. 4 shows only one of the annular sections 6 and one of the radial sections 8 of the screening plate 3 shown in FIGS. 2 and 3.

As described above, the at least one annular section 6 and the at least one radial section 8 are connected to one another in the region of the connecting section 9. Advantageously, the at least one annular section 6 and the at least one radial section 8, as shown in the present exemplary embodiment, each have at least one correspondingly designed connecting recess 10. The at least one annular section 6 and the at least one radial section 8 can be slid into one another in the region of the at least one connecting recess 10. Due to the insertion and/or due to a subsequent joining process, the at least one annular section 6 and the at least one radial section 8 can be non-displaceably connected to one another.

The present subject matter is not limited to the exemplary embodiments that have been shown and described. Modifications within the scope of the claims are also possible, as is any combination of the features, even if they are represented and described in different exemplary embodiments.

### LIST OF REFERENCE CHARACTERS

1 filter disk
2 device
3 screening plate
4 openings
5 supporting structure
6 annular section
7 stiffening ring
8 radial section
9 connecting section
10 connecting recess
11 angle
12 outer fastening contour
13 inner fastening contour
14 support surface
15 sliding element
16 tank
17 sludge
18 liquid
19 inlet
20 base
21 outlet
22 outlet
23 scraper
24 cleaning device
25 drive shaft
26 drive
27 sleeve
28 collar
29 fastening element
DA rotational axis
RR radial direction

1-16. (canceled)

17. A filter disk for a device for dewatering sludge, the filter disk comprising:
a screening plate having a plurality of openings for the passage of liquid, the screening plate being substantially circular; and
a supporting structure for supporting and/or stiffening the screening plate, the supporting structure having at least one annular section.

18. The filter disk of claim 17, wherein the at least one annular section forms at least one stiffening ring, the at least one stiffening ring having a circular shape or a regular polygonal shape or the at least one stiffening ring being configured as an endless ring.

19. The filter disk of claim 17, wherein the at least one annular section extends concentrically around a rotational axis of the filter disk.

20. The filter disk of claim 17, wherein the supporting structure has at least one radial section (8) that extends along a radial direction of the filter disk.

21. The filter disk of claim 20, wherein the at least one annular section and the at least one radial section are connected to one another at a connecting section in a non-displaceable manner.

22. The filter disk of claim 21, wherein the at least one annular section and the at least one radial section each have at least one correspondingly designed connecting recess such that the at least one annular section and the at least one radial section are insertable into one another in the region of the corresponding connecting recesses to form the connecting section.

23. The filter disk of claim 17, wherein the at least one annular section includes a plurality of annular sections, with each of the plurality of annular sections forming a stiffening ring of a plurality of stiffening rings, the plurality of stiffening rings being spaced apart from one another along a radial direction of the filter disk.

24. The filter disk of claim 17, wherein the supporting structure includes a plurality of radial sections extending along a radial direction of the filter disk, the plurality of radial sections being uniformly offset from one another by an angle.

25. The filter disk of claim 17, wherein the screening plate has a hole pitch in a range from 0.5 millimeters (mm) to 4 mm; and/or
the screening plate has round and/or polygonal openings, with the openings having a hydraulic diameter in a range from 0.5 mm to 2 mm.

26. The filter disk of claim 17, wherein the filter disk further includes an outer fastening contour and/or an inner fastening contour.

27. The filter disk of claim 26, wherein the supporting structure, along with the outer fastening contour and/or the inner fastening contour, define a support surface for the screening plate.

28. The filter disk of claim 26, wherein the supporting structure and one or both of the outer fastening contour and the inner fastening contour are arranged next to one another and/or are non-displaceably connected to one another.

29. The filter disk of claim 17, wherein the filter disk includes at least one sliding element for placing and/or sliding the filter disk on a tank of the device.

30. The filter disk of claim 29, wherein the sliding element is arranged on an outer fastening contour of the filter disk along a side of the outer fastening contour opposite the screening plate.

31. A device for dewatering sludge, the device comprising:
a filter disk for receiving the sludge; and
a tank in which the filter disk is mounted so as to be rotatable about a rotational axis,
wherein the filter disk comprises:
a screening plate having a plurality of openings for the passage of liquid, the screening plate being substantially circular; and
a supporting structure for supporting and/or stiffening the screening plate, the supporting structure having at least one annular section.

32. The use of the filter disk in the device of claim 31 for dewatering sludge.
